(19) United States
(12) Patent Application Publication
(10) Pub. No.: US 2021/0086383 A1
(43) Pub. Date: Mar. 25, 2021

(54) Methods and Apparatuses for Material Cutting

(71) Applicant: Perry Teri Toys, LLC, Cooper City, FL (US)

(72) Inventor: Perry Scott Kaye, Cooper City, FL (US)

(21) Appl. No.: 16/970,617

(22) PCT Filed: Feb. 15, 2018
(86) PCT No.: PCT/US2018/018454

§ 371 Date: Aug. 17, 2020

Related U.S. Application Data
(60) Provisional application No. 62/459,571, filed on Feb. 15, 2017.

(51) Int. Cl. B26B 29/06; B26B 5/00

(52) U.S. Cl. CPC B26B 29/06; B26B 27/007; B26B 5/005

(57) ABSTRACT

A portable, non-invasive, multipurpose cutting device requiring minimal manual manipulation. The device comprises a handle, at least one bearing, and a base. Some devices contain a blade in various configurations. The device makes cutting material precise, easy, and fun. Guides and accessories make the device appealing and interactive.

### PRIORITY CLAIM

This application is a national stage application of PCT/US18/18454, entitled Methods and Apparatuses for Material Cutting, having a filing date of Feb. 15, 2018, and which claims priority to US provisional application number 62,459,571, filed on Feb. 15, 2017 in its entirety.

### FIELD OF THE DISCLOSURE

The present disclosure relates to methods and apparatuses for material cutting. More specifically, the present disclosure presents a portable, non-invasive, multipurpose cutting device requiring minimal manual manipulation.

### BACKGROUND OF THE DISCLOSURE

Tablet computers and portable electronic devices are popular for generating digital art. A person typically uses a touch-screen device with peripherals such as a stylus, mouse, trackpad, joystick, rollerball, keyboard, game controller, matrix mousepad, or a dial such as the popular type used with the Microsoft Surface devices. The peripheral connects and communicates with the digital device such as a computer or a tablet. A person may also simply create digital art by using his/her fingers.

Many people turn to such digital options because they are relatively simple and ofTer more precision, especially for more delicate and intricate projects. People have become more accustomed to performing these digital artistic tasks such as manipulating a Surface Dial or joystick to create art on screen.

Due to the increase in use of digital art implements, people have become accustomed to utilizing fine motor skills and smaller movements to create art. For example, the old-fashioned way to create a paper snowflake is to fold the paper, grab scissors, and use the entire hand to manipulate the scissors to attempt to make small cuts in the paper. This is neither easy nor precise.

### SUMMARY OF THE DISCLOSURE

What is needed are methods and apparatuses for material cutting that allows a user to accurately and precisely cut through material. A user moves the apparatus along a surface to cut shapes and patterns. The apparatus can be formed in both large and small, fingertip-sized configurations. The apparatus can be configured with guides, accessories, and various blade configurations. A basic apparatus comprises a handle, at least one bearing, and a base.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure.

FIG. 1 shows an exploded view of an exemplary apparatus for material cutting.

FIG. 2 shows a side sectional view of an exemplary apparatus for material cutting.

FIG. 3 shows a perspective view of an exemplary apparatus for material cutting.

FIG. 4 shows an exploded view of an exemplary apparatus for material cutting.

FIG. 5a shows a perspective view of an exemplary apparatus for material cutting.

FIG. 5b shows a side sectional view of an exemplary apparatus for material cutting.

FIG. 6 shows a perspective view of a person using an exemplary apparatus for material cutting.

### REFERENCE NUMERALS OF THE DRAWINGS

1 Device
3 Proximal end
5 Distal end
7 Rotational portion
9 Non-rotational portion
11 Handle
13 Bearing
15 Base
17 Indentations
19 Core
21 Base hollow
23 Base side
25 Base inner surface
26 Depth gauge
27 Base outer surface
28 Blade shaft
29 Guide indicator
31 Blade skid
33 Blade
35 Protruding arrow
37 Protruding feet
39 Blade holder
40 Depth stop
41 Paper guide
43 Control object
45 Surface
47 Device accessory

### DETAILED DESCRIPTION

The present disclosure provides generally for methods and apparatuses for material cutting. According to the present disclosure, a device generally comprises a rotational portion, a non-rotational portion, and a blade. In some embodiments a device comprises a handle which may be a non-rotational portion, a bearing, a base which may be a rotational portion, a blade, and a blade holder. A device may also include accessories. A device may be used to cut material. A base is at the distal end of the device is may be applied to the surface. A handle is at the proximal end of the device and may accommodate a person's finger.

A device may be controlled by a single fingertip, multiple fingertips, or by grasping with a hand. A device may also be controlled by a foot, toe, nose, tongue, elbow, knuckle, or a separate device complementary to a handle. A handle may have indentations, varying shapes, and varying textures to accommodate the part of a person or object applied to the handle to control the device.

A device may be used by placing a base on material, placing a finger on a handle, applying pressure, and applying push force. A user may change the direction in which a device travels by flexing, extending, and rotating the finger while the fingertip is placed on the handle. A bearing will allow for the base to independently rotate from the handle, so that the blade direction will substantially correlate with the direction of the push forces applied to the device.

The movements a person uses to control a device may be similar to the movements used with digital peripheral devices. The device moves about the surface of the material. A combination of gravity, pressure, push forces, rotation, drag, and friction cause the device blade to cut the material. Cutting the material is substantially independent of velocity. In other words, the device may cut material substantially independently from changes in velocity during normal and expected use of the device.

In the following sections, detailed descriptions of examples and methods of the disclosure will be given. The description of both preferred and alternative examples are exemplary only, and it is understood that to those skilled in the art that variations, modifications, and alterations may be apparent. It is therefore to be understood that the examples do not limit the broadness of the aspects of the underlying disclosure as defined by the claims.

### Glossary

“device” as used herein means a material cutting apparatus.

“material” as used herein means a surface that can be cut.

“blade” as used herein means any object with a sharp edge or point.

“control object” as used herein means a fingertip, hand, foot, toe, nose, elbow, pencil, pen, stick, handle add-on, accessory, or anything that can be accommodated by a handle and can be used to exert push forces on the device.”

“handle add-on” as used herein means any extension such as a nob removably applied to the handle.

“guide indicator” as used herein means an arrow, shape, image, texture, protrusion, color, or any other indicator that aids in orienting the parson, guiding the cutting path, and aligning the device.

### DETAILED DESCRIPTIONS OF THE DRAWINGS

Devices may be modular, have some parts fixedly combined as a single assembly, or may be completely fixedly combined into a single assembly.

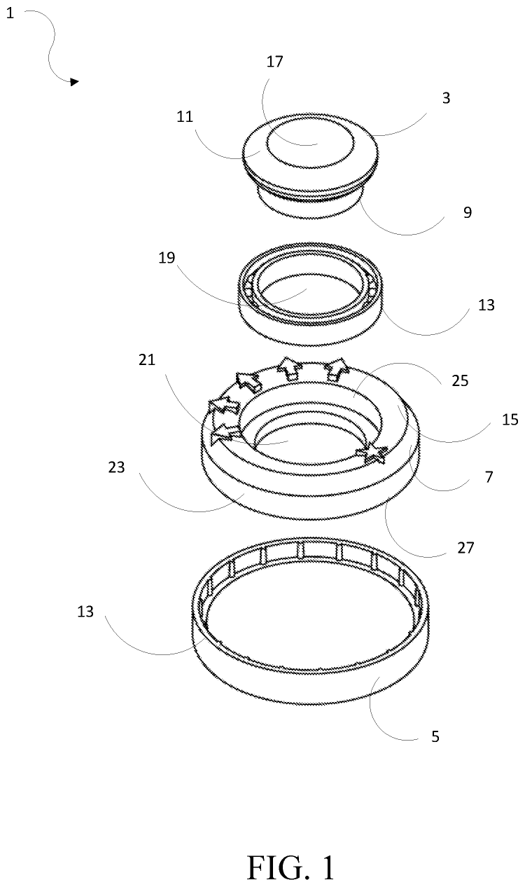

Referring to FIG. 1, an exploded view of an exemplary apparatus for material cutting is shown. The device 1 is shown having a proximal end 3 and a distal end 5. A handle 11 is shown with an indentation 17. A bearing 13, specifically a top or proximal bearing, is shown with a core 19. A base 15 is shown having a base inner surface 25, a base outer surface 27, a base side 23, a base hollow or inner base space 21. The device may contain a rotational portion 7 and a non-rotational portion 9. The device may contain a second, bottom, or distal bearing 13.

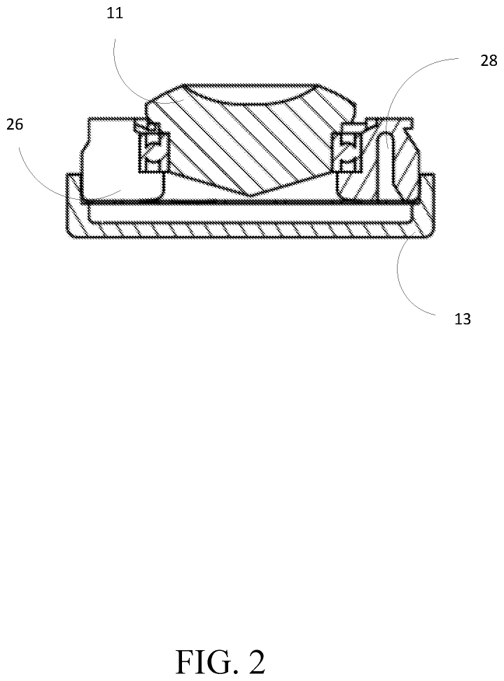

Referring to FIG. 2, a side sectional view of an exemplary apparatus for material cutting is shown. The device 1 may be configured with a depth gauge 26, handle 11, bearing 13, and a blade shaft 28.

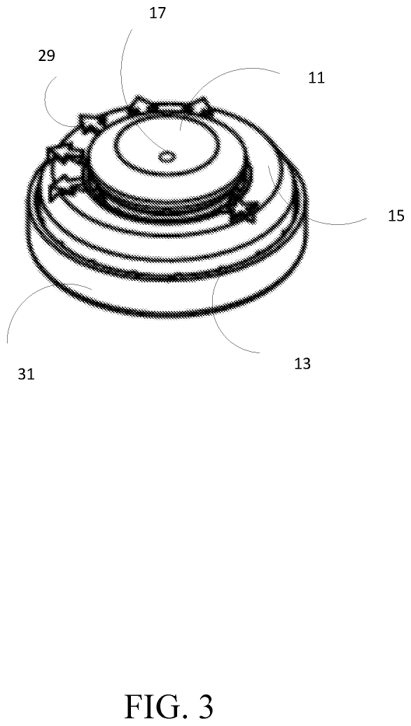

Referring to FIG. 3, a perspective view of an exemplary apparatus for material cutting is shown. The device may be configured with a blade skid 31, guide indicator 29, handle 11 with an indentation 17, a base 15, and at least one bearing 13.

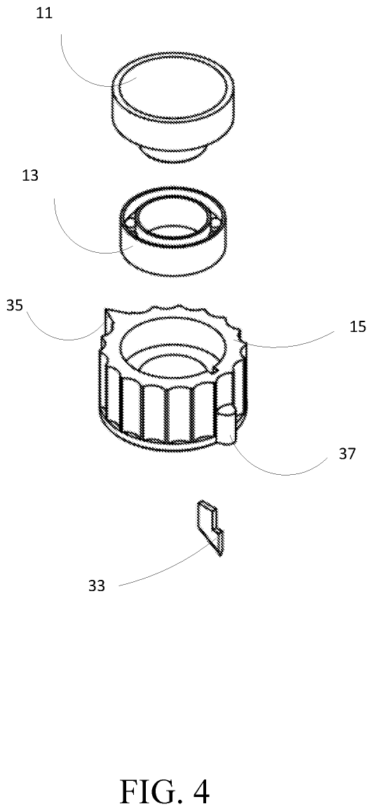

Referring to FIG. 4, an exploded view of an exemplary embodiment of an apparatus for material cutting is shown. A device may be configured in a smaller form approximately the circumference of a finger and may comprise a handle 11 with a bearing 13, a base 15, a protruding arrow 35, a blade 33, and at least one protruding foot 37.

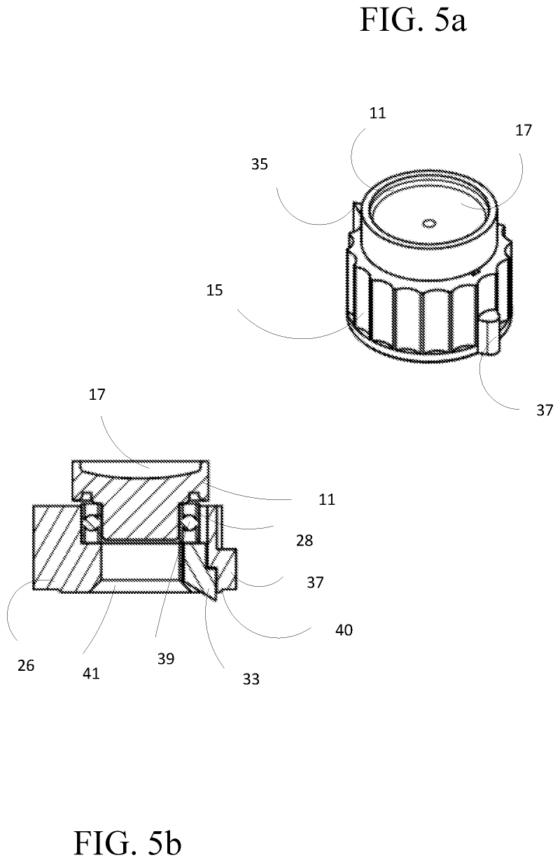

Referring to FIGS. 5a and 5b, a perspective view and a side sectional view are shown respectively. An exemplary device may be configured with a depth gauge 26, a paper guide 41, a blade holder 39, a blade 33, a depth stop 40, a protruding foot 37, a blade shaft 28, and a handle 11 with an indentation 17 suitable for accommodating a finger. Some embodiments may further comprise a protruding arrow 35.

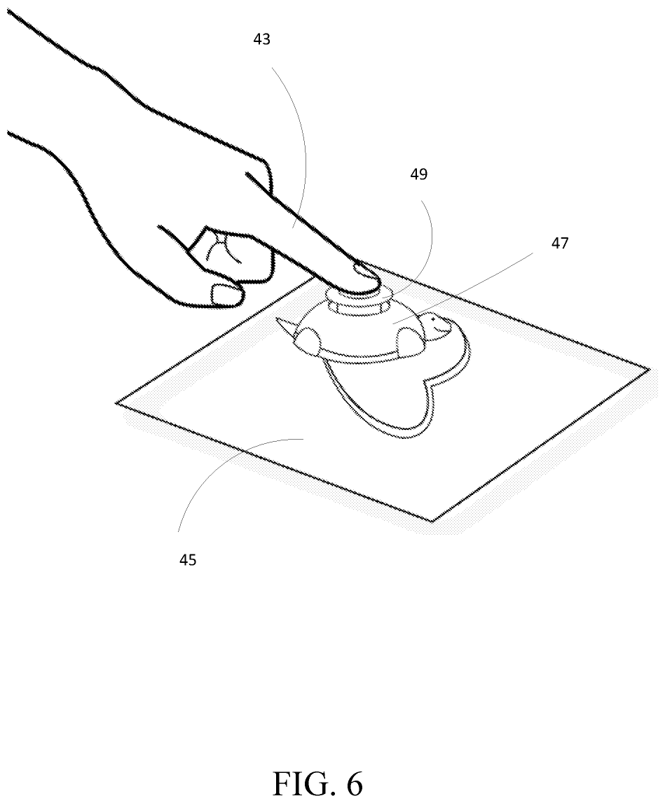

Referring to FIG. 6, an exemplary embodiment of a person using the device with an accessory is shown. A control object 43 is placed on a handle add-on 49 connected to a handle accessory 47 which is applied to a surface 45 for cutting. Accessories may snap on to a handle. Exemplary functional accessories are shown such as an arrow or a magnifier that snap onto the sides of the handle.

Accessories may be fixably or removably attached to a base, a handle, or both. An accessory may be functional or decorative. A functional accessory may be a magnifier or an arrow. A decorative accessory may be a flower or a character. An accessory may wrap or snap about the outer edges of the handle, the base, or both. An accessory may be a handle add-on and vice versa. A handle add-on may be a nob, like a joystick. Accessories may be interchangeable.

In some embodiments, a device may have a handle with a core that fits concentrically through a bearing. The bearing with the handle fit concentrically inside the hollow of a base. The base may have sculpted sides, a protruding arrow, and protruding feet. The base may have an offset blade holder and blade position.

In another embodiment, a device may have a handle with a bearing that frictionally fits in the handle hollow. The device may have a base that is wider than the handle and has a center core protrusion that concentrically fits inside a bearing. A bearing may frictionally fit inside the hollow center of the handle. The base may have sculpted edges and an arrow guide indicator. The base may contain a blade holder and blade spanning from the center core and through the other part of the base. A blade holder may be neither offset nor in the center.

An alternative embodiment of a device may contain a handle with a bearing frictionally fit concentrically inside the handle hollow core. The base may contain a core, blade holder, and blade in the center of the base. The base may have smooth, rounded edges and taper toward the central core.

An exemplary device may contain two protrusions and one blade holder and blade. In this embodiment, the base has a greater circumference than the handle. A device can have any number of protrusions, textures, depressions, cut-outs, blade holders, and blades. The bottom image shows the handle of an exemplary device. The handle contains a central depression to accommodate a control object. The top part of the base is shown having guide indicators.

Exemplary embodiments may have various configurations with the handle, blade holder, and blade positions. A device handle may be concentrically inserted into a base. A blade holder may be integrated with the handle. The blade holder and blade may be substantially in the center of the device. In another configuration, a base contains a bearing, and a handle is inserted concentrically into the hollow of the base. The base may be wider than the handle. A blade holder and blade may be present at the outer part of the base. The blade may not be aligned in the center and is substantially offset instead. In another configuration, a device may have a base that is concentrically inserted inside the hollow of a handle. The base may contain a blade holder and a blade substantially in the center of the device.

In some embodiments, a device may have a base that concentrically fits inside a handle. The base further includes notches to minimize the surface area of the base that comes in contact with material. The second image shows a hand that fits concentrically within a base. The base may have inter-base space between the inner and outer surfaces of the base. The inter-base space may be continuous or discontinuous. The third image shows an exemplary device with a base having a core that extends concentrically into a bearing in a handle. The base has outer contours and an arrow. The base also has protrusions to reduce contact of the base with material to reduce friction and to ease movement. A base may have various textures and materials.

In some embodiments, a device comprises a handle, a bearing, a blade holder, an arrow, a paper guide, and a blade. An arrow may be an accessory or formed as part of the base or the blade holder. The arrow may be used to indicate to a person in which direction to apply push forces. In some embodiments, a blade with a diagonal, triangular, or chiseled tip may be placed at the opposite end of a base with the hypotenuse end facing away from the device. Drag and rudder-type forces may be facilitated and will guide the cutting path of the blade to match the direction of the arrow. If a person applies force in a different direction, the base with blade holder and blade will rotate independently from the stationary handle to maintain the directional relationship between the arrow and the blade tip.

In some embodiments, a blade shaft may be attached to a top bearing. In some embodiments, a blade may be attached to a bottom bearing. In some embodiments, a handle may be attached to a top bearing. A blade skid may be attached to a bottom bearing or to a base. A blade and a blade shaft may fixably or removably accommodate a handle and a blade skid. In some embodiments, a blade and a blade shaft or a blade holder may be one assembly.

A device may also be without a blade. Blades may be changeable. Blades may also have various configurations pertaining to angle and depth. Blades may in in a safety configuration or may be in an aggressive configuration. A safety configuration may have the blade protruding approximately from 1 to approximately 5 millimeters. An aggressive configuration may have the blade protruding from approximately 3 to approximately 10 millimeters.

A device may have various bearing such as a roller bearing and/or a thrust bearing. In some embodiments, the blade may be fixably or removably attached to a thrust bearing. A bearing or a base may have a partial conic shape with a central button or saddle at the center of gravity to improve aesthetics, improve rotation and orientation, and provide a better view of the material to be cut.

A cross section of an exemplary blade shaft, depth gauge, and depth stop of a device is shown. An exemplary device may comprise a magnet, a blade, a depth gauge, a blade shaft, a depth stop, a base, and a handle.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. Nevertheless, it will be understood that various modifications may be made without departing from the spirit and scope of the claimed disclosure.

What is claimed is:

1. A device for material cutting, the device comprising:
a handle,
a bearing, and
a base.

2. The device of claim 1 further comprising a blade, a blade holder, and a blade shaft.

3. The device of claim 2 further comprising a depth stop.

4. The device of claim 2 further comprising a depth gauge.

5. The device of claim 2 further comprising a handle add-on.

6. The device of claim 2 further comprising an accessory.

7. The device of claim 6 wherein the accessory is a character.

8. The device of claim 1 further comprising a second bearing at a distal end.

9. The device of claim 8 wherein the bearing is concentrically aligned between the handle at a proximal end and the base at the distal end, and the second bearing is linear aligned at a distal end of the base.

10. The device of claim 9 wherein the handle is non-rotational, and the base is rotational.

11. The device of claim 10 further comprising a guide indicator on the base.

12. The device of claim 2 wherein the blade is in an aggressive configuration.

13. The device of claim 2 wherein the blade is in a safety configuration.

14. The device of claim 1 further comprising protrusions to reduce contact of the base with material to reduce friction and to ease movement.

15. The device of claim 8 wherein the second bearing at the distal end of the base further comprises a blade skid.

16. The device of claim 1 wherein the handle contains an indentation suitable for accommodating a finger.

17. A method of cutting material using a device for material cutting comprising a handle, a bearing, a base, and a blade, the method comprising the steps:
placing the device on a surface suitable to be cut by a blade;
applying a force with control object to the handle of the device;
facilitating movement of the device along the surface; and
cutting the surface along a path of movement.

18. The method of claim 17 wherein the control object in a finger.

19. The method of claim 17 whereby the movement facilitated is a dragging force.

20. The method of claim 17 whereby the movement facilitated in a rudder force.
